(19) United States
(12) Patent Application Publication
(10) Pub. No.: US 2025/0129889 A1
(43) Pub. Date: Apr. 24, 2025

(54) METHOD AND DEVICE FOR TRANSFERRING CRYOGENIC FLUID

(71) Applicant: L'Air Liquide, Societe Anonyme pour l'Etude et l’Exploitation des Procedes Georges Claude, Paris (FR)

(72) Inventors: Claire GIRARD, Les Loges-En-Josas (FR); Anh Thao THIEU, Les Loges-En-Josas (FR)

(73) Assignee: L'Air Liquide, Societe Anonyme pour l'Etude et l’Exploitation des Procedes Georges Claude, Paris (FR)

(21) Appl. No.: 18/689,834

(22) PCT Filed: Jun. 30, 2022
(86) PCT No.: PCT/EP2022/068117

§ 371 Date: Mar. 6, 2024

(30) Foreign Application Priority Data
Sep. 6, 2021 (FR) FR 2109289

(51) Int. Cl. F17C 7/00

(52) U.S. Cl. CPC F17C 7/00; F17C 2205/0323; F17C 2205/0352; F17C 2221/012; F17C 2223/0161; F17C 2227/0157; F17C 2265/061; F17C 2270/0171

(57) ABSTRACT

The invention relates to a method and installation for transferring cryogenic fluid using a cryogenic-fluid transfer device comprising a first cryogenic-fluid distribution tank, said distribution tank storing a cryogenic fluid with a lower liquid phase and an upper gas phase, a second cryogenic receiving tank accommodating a cryogenic fluid comprising a lower liquid phase and an upper gas phase, a fluid transfer circuit connecting the first and the second tank, the transfer circuit comprising a first pipe connecting the upper parts of the first and second tanks and comprising at least one compressor configured to draw gas to be compressed from the receiving tank and to deliver the compressed gas into the distribution tank, the transfer circuit comprising a second pipe connecting the lower part of the distribution tank to the upper part of the receiving tank, the method comprising a step of pressurizing the distribution tank using the compressor via the first pipe and a step of transferring liquid from the distribution tank to the receiving tank by way of a pressure difference between the two tanks, the liquid being transferred into the upper part of the receiving tank.

### CROSS REFERENCE TO RELATED APPLICATIONS

This application is a § 371 of International PCT Application PCT/EP2022/066130, filed Jun. 14, 2022, which claims the benefit of FR2107747, filed Jul. 19, 2021, both of which are herein incorporated by reference in their entireties.

### FIELD OF THE INVENTION

The invention relates to a method and a device for transferring cryogenic fluid.

### BACKGROUND OF THE INVENTION

In order to refuel a cryogenic tank, in particular with liquefied hydrogen, the cryogenic liquid has to be transferred from the semi-trailer to the customer tank by way of a pressure difference. The receiving tank is generally at a higher pressure than the pressure of the delivery tank.

In order to carry out this transfer, two methods are currently available.

A first method carries out an active transfer using a transfer pump. The cryogenic liquid in the semi-trailer is pressurized by means of a high-flowrate cryogenic pump. This makes it possible to overcome the pressure difference between the two tanks in order to carry out the transfer. On account of the operational transfer speed requirements, this pump is most commonly a centrifugal pump that is capable of creating pressure differences between 1 and 25 bar. These centrifugal pumps create pressure on the basis of the density of the fluid. For low-density gases such as liquid hydrogen or liquid helium, it is technically difficult to manufacture a transfer pump that can create the required pressure differential (for example between 1 and 10 bar). In addition, a transfer pump entails other disadvantages. Specifically, by pumping liquid, the pump adds heat to the fluid to be transferred, and risks damage by cavitation within the cryogenic liquid. In addition, semi-trailers always have to be equipped with an atmospheric heater in order to vaporize a portion of the liquid and to compensate for the drop in pressure linked to unloading liquid from the truck.

Another method carries out a transfer using pressurization. The transfer is principally carried out by pressurizing the semi-trailer to a pressure typically of 0.5 to 2 bar above the pressure of the fixed tank to be filled using an atmospheric heater. That is to say that cold liquid is withdrawn from the semi-trailer by gravity, then vaporized in an exchanger, typically an atmospheric exchanger, located at a low point of the tank, and then naturally returned to the tank. This results in pressurization of the semi-trailer. The pressurization speed typically depends on the size of the exchanger and on the diameter of the pipework, and the head that causes the fluid to circulate. The pressurization of the delivery tank allows a (passive) transfer of liquid toward the tank to be filled by way of a pressure differential by creating a fluidic connection.

This type of device is slow, dependent on the height of liquid available in the semi-trailer, and injects heat into the system while consuming liquid. This therefore results in gas losses by evaporation in the logistics loop of the cryogenic liquid.

Document WO2019173445A1 describes a liquid-transfer system that uses a compressor between the gas portions of the two tanks.

This device requires numerous transfer pipes in order to manage the pressure between the two tanks.

One aim of the present invention is to overcome all or some of the disadvantages of the prior art that are set out above.

### SUMMARY OF THE INVENTION

The invention relates more particularly to a method for transferring cryogenic fluid using a device for transferring cryogenic fluid comprising a first tank for distributing cryogenic fluid, said first tank storing a cryogenic fluid with a liquid lower phase and a gas upper phase, a receiving second cryogenic tank housing a cryogenic fluid comprising a liquid lower phase and a gas upper phase, a fluid-transfer circuit connecting the first tank and the second tank, the transfer circuit comprising a first pipe connecting the upper portions of the first and second tanks and comprising at least one compressor configured to draw gas to be compressed from the second tank and to discharge the compressed gas into the first tank.

In an effort to overcome the deficiencies of the prior art discussed, supra, the method according to certain embodiments of the invention, which is otherwise in accordance with the generic definition thereof given in the preamble above, has a transfer circuit that may include a second pipe connecting the lower portion of the first tank to the upper portion of the second tank, the method comprising a step of pressurizing the first tank by the compressor via the first pipe and a step of transferring liquid from the first tank to the second tank by way of a pressure differential between the two tanks, the liquid being transferred into the upper portion of the second tank.

Moreover, embodiments of the invention may comprise one or more of the following features:
the first pipe and the second pipe are connected to the upper portion of the second tank at the same common orifice,
during at least part of the step of pressurizing the first tank, the second pipe is closed,
the step of pressurizing the first tank is configured to bring the pressure in the first tank to a pressure level that exceeds the pressure in the second tank by a value of between 0.2 and 5 bar, and preferably of between 0.5 and 2 bar,
the step of pressurizing the first tank is carried out during at least part of the step of transferring liquid from the first tank to the second tank,
the step of pressurizing the first tank is preceded by a step of equalizing the pressure between the two tanks,
the step of equalizing the pressure between the two tanks is carried out by way of passive pressure equalization via the first pipe,
the step of equalizing the pressure between the two tanks is carried out by way of active pressure equalization via the first pipe and pumping by the compressor,
the step of equalizing the pressure between the two tanks is configured to bring the pressure differential between the two tanks to a level lower than a determined value, for example lower than 1 bar,
the pressure equalization step is preceded by at least one of the following: a step of flushing at least one portion of the pipes, a step of cooling at least one portion of the pipes,
the method comprises a step of heating the gas to be compressed before it is admitted into the compressor during the pressurization step, the heating step comprising an exchange of heat between the gas to be compressed and a relatively warmer heat-transfer fluid.

The invention also relates to an installation for transferring cryogenic fluid comprising a first tank, which is for example mobile, for distributing cryogenic fluid, said first tank being configured to store a cryogenic fluid with a liquid lower phase and a gas upper phase, a receiving second cryogenic tank configured to contain a cryogenic fluid comprising a liquid lower phase and a gas upper phase, a fluid-transfer circuit configured to connect the first tank and the second tank, the transfer circuit comprising a first pipe configured to connect the upper portions of the first and second tanks and comprising at least one compressor configured to draw gas to be compressed from the second tank and to discharge the compressed gas into the first tank, the transfer circuit comprising a second pipe configured to connect the lower portion of the first tank to the upper portion of the second tank, the installation comprising a set of one or more valves and an electronic control member comprising a microprocessor, the control member being configured to control the compressor and the set of one or more valves in order to allow the first tank to be pressurized by the compressor via the first pipe and to transfer liquid from the first tank to the second tank by way of a pressure differential between the two tanks.

The invention may also relate to any alternative device or method comprising any combination of the features above or below within the scope of the claims.

### BRIEF DESCRIPTION OF THE DRAWINGS

These and other features, aspects, and advantages of the present invention will become better understood with regard to the following description, claims, and accompanying drawings. It is to be noted, however, that the drawings illustrate only several embodiments of the invention and are therefore not to be considered limiting of the invention's scope as it can admit to other equally effective embodiments.

Other particular features and advantages will become apparent from reading the following description, which is provided with reference to the figures, in which:

FIG. 1 shows a schematic, partial view illustrating the structure and the operation of an example of a device according to the invention in a first embodiment,

FIG. 2 shows a schematic, partial view illustrating the structure and the operation of an example of a device according to the invention in a second embodiment,

FIG. 3 shows a schematic, partial view illustrating the structure and the operation of an example of a device according to the invention in a third embodiment.

### DETAILED DESCRIPTION OF THE INVENTION

As illustrated, the installation for transferring cryogenic fluid comprises a first tank 2 for distributing cryogenic fluid, for example a mobile, vacuum-insulated cryogenic tank (for example carried by a truck).

The first tank 2 is configured to store a cryogenic fluid with a liquid lower phase and a gas upper phase. The installation comprises a receiving second cryogenic tank 3 that is to be filled and is configured to contain a cryogenic fluid comprising a liquid lower phase and a gas upper phase.

The installation comprises a fluid-transfer circuit configured to connect the first tank 2 and the second tank 3, for example in a detachable manner, at least at the second tank 3 to be filled (for example via quick or detachable connectors). Alternatively or cumulatively, the transfer circuit may be detachable from the first tank 2 and fixed to or detachable from the second tank 3.

The transfer circuit comprises a first pipe 4 connecting the upper portions of the first 2 and second 3 tanks and comprising at least one compressor 5.

The compressor 5 is configured to draw gas to be compressed from the second tank 3 and to discharge the compressed gas into the first tank 2.

The transfer circuit comprises a second pipe 6 connecting the lower portion of the first tank 2 to the upper portion of the second tank 3.

The installation is configured to allow the first tank 2 to be pressurized by the compressor 5 via the first pipe 4 and to allow liquid to be transferred from the first tank 2 to the second tank 3 by way of a pressure differential between the two tanks 2, 3. During this transfer, the liquid is transferred into the upper portion of the second tank 3.

In particular, the installation may comprise a set of one or more valves 10 and may comprise an electronic control member 9 comprising a microprocessor. The control member 9 may comprise a computer or an electronic controller and is preferably configured (programmed) to control the compressor 5 and the set of one or more valves 10 in order to allow the first tank 2 to be pressurized by the compressor 5 via the first pipe 4 and also to ensure the transfer of the liquid from the first tank 2 to the second tank 3 by way of a pressure differential between the two tanks 2, 3 (passive automatic transfer of liquid on account of the pressure difference created by the abovementioned pressurization).

This structure allows the pressure difference between the tanks 2, 3 to be overcome and allows the liquid to be transferred by using a cryogenic compressor 5 on the gas circuit instead of a cryogenic pump on the liquid circuit. That is to say that the second pipe 6 for transferring liquid may comprise only passive members (one or more valves or the like) and does not require an active transfer member such as a pump in order to carry out the transfer of liquid.

During the transfer of liquid via the second pipe 6, the compressor 5 preferably circulates gas from the second tank 3 to be filled to the first tank 2. Preferably, the compressor is controlled in order to maintain a higher pressure in the first tank 2. This pressure difference causes the liquid to be moved in the other direction in the second pipe 6.

In the case of hydrogen, the first tank 2 generally arrives with a pressure typically of between 1 and 6 bara. The deliverer then fluidically connects the two tanks 2, 3 by way of two connections: a liquid connection between the bottom of the first tank 2 and the top of the second tank 3 (second pipe 6) and a gas connection between the two upper portions of the two tanks 2, 3 (first pipe 4). Preferably, these two pipes or the ends thereof are closed (set of one or more valves 10, for example).

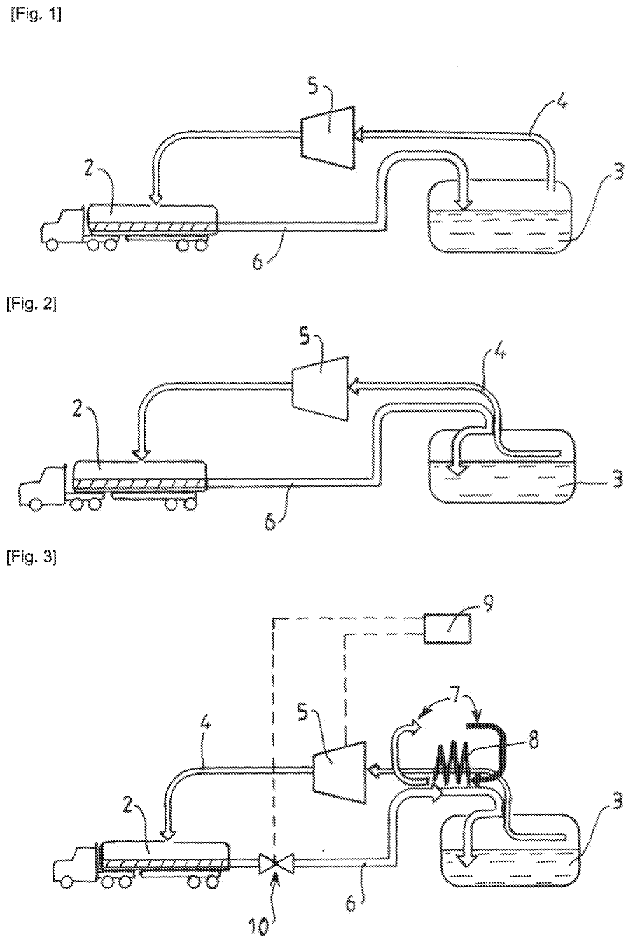

As illustrated in [FIG. 1], the two pipes 2, 3 may be connected to the second tank 3 at separate inlets or, as shown in [FIG. 2], at a single common inlet. The latter configuration with just one upper opening simplifies the structure of the tank 3 and may improve the thermal performance thereof.

After the operations of inerting the pipes 4, 6 and circuit, of flushing and cooling the pipework, the fluidic connection may be established between the two tanks 2, 3 for example via the first pipe 4 (opening of the one or more valves, for example). This allows passive pressure equalization to be carried out between the two tanks 2, 3 via the gas headspace thereof. For example, this pressure equalization may be carried out through the compressor 5 (which is not switched on at this point) and/or via a bypass of the compressor 5.

When the pressure difference between the two tanks 2, 3 is reduced to a determined level, for example close to 0 bar (lower than 1 bar, for example), the compressor 3 may be switched on in order to accelerate the equalization.

The target equalization point is preferably at an intermediate pressure between the two pressures of the two tanks, typically between 2 and 8 bar. It depends, in particular, on the initial pressure in the two tanks 2, 3 and on the liquid level in the first tank 2 and on the volumes of the two tanks 2, 3.

The compressor 5 continues to increase the pressure in the first tank 2 with respect to the second tank 3.

When the pressure of the first tank 2 starts to exceed that of the second tank 3, the second pipe 6 may be opened (for example via one or more valves 10, as illustrated schematically in [FIG. 3]). The transfer of liquid thus starts.

The speed or power of the compressor 3 may be regulated in order to keep the pressure in the first tank 2 at a constant determined value (for example 1 to 2 bar above the pressure in the second tank 3). In this case, the compressor 5 is controlled in order to transfer the same volume of gas from the second tank 3 to the first tank 2 as the volume of liquid that is transferred in the other direction.

The filling of the second tank 3 may be finished once a determined level has been reached in the second tank 3, for example the maximum permissible level in the second tank.

The compressor 3 is preferably a centrifugal compressor, which is thermally insulated in order to limit external inputs of heat. It may be installed at the first tank 2 (for example on the vehicle transporting the latter). Of course, the compressor could be integrated into the installation comprising the second tank 3. The compressor 3 may be supplied with power for example by an electrical cabinet or a hydraulic unit coupled to the engine of the vehicle transporting the first tank 2. Preferably, the compressor 3 has a power that is lower than 10 kW.

As illustrated in [FIG. 3], a heat exchanger 8 may be installed on the first pipe 4 between the outlet of the second tank 3 and the inlet of the compressor 3 in order to heat the gas for example by exchange with a heat-transfer fluid 7. This makes it possible to reduce the size of the compressor 3 or to use a relatively “warmer” compressor (i.e. a compressor that is not configured for very low cryogenic temperatures). The cold energy recovered from the heated gas may be stored (for example in a mass with thermal inertia) in order to be reused for example for filling tanks with gas (hydrogen, for example: cooling the gas transferred under pressure into a tank).

The invention has a number of advantages.

Transferring liquid into the second tank 3 at the top allows the pressure therein to be reduced or avoids an increase in pressure. This allows there to be just one access opening in the second tank 3, which reduces the possibility of inputs of heat. In addition, the temperature of the gas recovered is more homogeneous: there is less variation in density and this is easier to manage in the compressor.

The device and in particular the first tank 2 do not require an atmospheric heater (or may be equipped with a smaller atmospheric heater).

The time spent transferring liquid is reduced since the time spent pressurizing the first tank is significantly reduced. The saving is estimated to be of the order of 30 min to 2 hours per delivery.

The introduction of heat into the system is furthermore at a minimum since the gas evaporated from the second tank is used in order to create the transfer pressure. The compressor 5 preferably causes only a very small pressure difference (of the order of 1 bar, for example). The vaporization (“boil-off”) loss is therefore at a minimum in the logistics chain. The liquid contained in the first tank 2 is not vaporized in order to pressurize this first tank 2. The efficiency of the logistics chain is improved (the amount of liquid delivered to customers relative to the amount lost increases).

A steam compressor is more solid and reliable than a cryogenic pump that is more sensitive to cavitation.

The compressor 3 does not add any heat into the transferred liquid, which allows customers to be supplied with colder, denser liquid. The second tank 3 therefore benefits from greater autonomy, which reduces refueling costs and increases the performance of the receiving station.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1-12. (canceled)

13. A method for transferring cryogenic fluid using a device for transferring cryogenic fluid, the method comprising the steps of:
providing the device comprising:
a distribution tank configured to store a cryogenic fluid with a liquid lower phase and a gas upper phase,
a receiving tank housing a cryogenic fluid comprising a liquid lower phase and a gas upper phase,
a fluid-transfer circuit connecting the distribution tank and the receiving tank, the fluid-transfer circuit comprising a first pipe connecting the upper portions of the distribution tank and the receiving tank and further comprising at least one compressor configured to draw gas to be compressed from the receiving tank and to discharge the compressed gas into the distribution tank, the fluid-transfer circuit further comprising a second pipe connecting the lower portion of the distribution tank to the receiving tank;
pressurizing the distribution tank by the compressor via the first pipe; and
transferring liquid from the distribution tank to the receiving tank by way of a pressure differential between the two tanks,
wherein the second pipe is connected to the upper portion of the receiving tank, and
wherein the liquid is transferred into the upper portion of the receiving tank.

14. The method as claimed in claim 13, wherein the first pipe and the second pipe are connected to the upper portion of the receiving tank at the same common orifice.

15. The method as claimed in claim 13, wherein, during at least part of the step of pressurizing the distribution tank, the second pipe is closed.

16. The method as claimed in claim 13, wherein the step of pressurizing the distribution tank is configured to bring the pressure in the distribution tank to a pressure level that exceeds the pressure in the receiving tank by a value of between 0.2 and 5 bar, and preferably of between 0.5 and 2 bar.

17. The method as claimed in claim 13, wherein the step of pressurizing the distribution tank is carried out during at least part of the step of transferring liquid from the distribution tank to the receiving tank.

18. The method as claimed in claim 13, wherein the step of pressurizing the distribution tank is preceded by a step of equalizing the pressure between the two tanks.

19. The method as claimed in claim 18, wherein the step of equalizing the pressure between the two tanks is carried out by way of passive pressure equalization via the first pipe.

20. The method as claimed in claim 18, wherein the step of equalizing the pressure between the two tanks is carried out by way of active pressure equalization via the first pipe and pumping by the compressor.

21. The method as claimed in claim 18, wherein the step of equalizing the pressure between the two tanks is configured to bring the pressure differential between the two tanks to a level lower than a determined value, for example lower than 1 bar.

22. The method as claimed in claim 18, wherein the step of equalizing the pressure between the two tanks is preceded by at least one of the following: a step of flushing at least one portion of the pipes and a step of cooling at least one portion of the pipes.

23. The method as claimed in claim 13, further comprising a step of heating the gas to be compressed before it is admitted into the compressor during the pressurization step, the heating step comprising an exchange of heat between the gas to be compressed and a relatively warmer heat-transfer fluid.

24. An installation for transferring cryogenic fluid, the installation comprising:
a distribution tank for distributing cryogenic fluid, said distribution tank being configured to store a cryogenic fluid with a liquid lower phase and a gas upper phase;
a receiving tank configured to contain a cryogenic fluid comprising a liquid lower phase and a gas upper phase;
a fluid-transfer circuit connecting the distribution tank and the receiving tank, the fluid-transfer circuit comprising a first pipe connecting the upper portions of the distribution tank and the receiving tank and further comprising at least one compressor configured to draw gas to be compressed from the receiving tank and to discharge the compressed gas into the distribution tank, the fluid-transfer circuit further comprising a second pipe connecting the lower portion of the distribution tank to the upper portion of the receiving tank;
a set of one or more valves; and
an electronic control member comprising a microprocessor, the electronic control member being configured to control the compressor and the set of one or more valves in order to allow the distribution tank to be pressurized by the compressor via the first pipe and to transfer liquid from the distribution tank to the receiving tank by way of a pressure differential between the distribution tank and the receiving tank.

25. The installation as claimed in claim 24, wherein the distribution tank is a mobile distribution tank.
